(19) United States
(12) Patent Application Publication
(10) Pub. No.: US 2001/0014726 A1
(43) Pub. Date: Aug. 16, 2001

(54) High molecular weight, gel-free isobutene copolymers with elevated double bond contents

(76) Inventors: Gerhard Langstein, Kurten (DE); Martin Bohnenpoll, leverkusen (DE); Ron Commander, Sarnia (CA)

Correspondence Address: BAYER CORPORATION, PATENT DEPARTMENT, 100 BAYER ROAD, PITTSBURGH, PA, 15205, US

(21) Appl. No.: 09/764,670

(22) Filed: Jan. 18, 2001

(30) Foreign Application Priority Data
Jan. 31, 2000 (DE) 10004048.9

(51) Int. Cl. C08F 2/00

(52) U.S. Cl. 526/217; 526/220; 526/348.7

(57) ABSTRACT

The present invention provides a novel process for the production of low-gel, high molecular weight isoolefin copolymers in the presence of vanadium compounds and organic nitro compounds, in particular for the production of butyl rubbers, and isoolefin copolymers synthesized from isobutene, isoprene and optionally further monomers with a comonomer content of greater than 2.5 mol %, a molecular weight M_{w} of greater than 240 kg/mol and a gel content of less than 1.2 wt. %.

### FIELD OF THE INVENTION

The present invention provides a novel process for the production of low-gel, high molecular weight isoolefin copolymers in the presence of vanadium compounds and organic nitro compounds, in particular for the production of butyl rubbers, and isoolefin copolymers synthesized from isobutene, isoprene and optionally further monomers with a comonomer content of greater than 2.5 mol %, a molecular weight M_{w} of greater than 240 kg/mol and a gel content of less than 1.2 wt. %.

### BACKGROUND OF THE INVENTION

The currently used production process for butyl rubber is known, for example, from Ullmanns Encyclopedia of Industrial Chemistry, volume A 23, 1993, pages 288-295. Cationic copolymerization of isobutene with isoprene in the slurry process with methyl chloride as process solvent is performed with aluminum trichloride as initiator with addition of small quantities of water or hydrogen chloride at −90° C. The low polymerization temperatures are required in order to achieve molecular weights which are sufficiently high for rubber applications.

Raising the reaction temperature or increasing the quantity of isoprene in the monomer feed results in more poor product properties, in particular, in lower molecular weights. However, a higher degree of unsaturation would be desirable for more efficient crosslinking with other, highly unsaturated diene rubbers (BR, NR or SBR).

The molecular weight depressing effect of diene comonomers may, in principle, be offset by still lower reaction temperatures. However, in this case the secondary reactions, which result in gelation occur to a greater extent. Gelation at reaction temperatures of around −120° C. and possible options for the reduction thereof have been described (cf W. A. Thaler, D. J. Buckley Sr., Meeting of the Rubber Division, ACS, Cleveland, Ohio, May 6-9, 1975, published in Rubber Chemistry & Technology 49, 960-966 (1976)). The auxiliary solvents such as CS₂ required for this purpose are not only difficult to handle, but must also be used at relatively high concentrations.

It is furthermore known to perform gel-free copolymerization of isobutene with various comonomers to yield products of a sufficiently high molecular weight for rubber applications at temperatures of around −40° C. using pretreated vanadium tetrachloride (EP-A1-818 476).

It is also possible to use this aged vanadium initiator system at relatively low temperatures and in the presence of an isoprene concentration which is higher than conventional (approx. 2 mol % in the feed), but, as with AlCl₃-catalyzed copolymerization at −120° C., in the presence of isoprene concentrations of>2.5 mol % this results in gelation even at temperatures of −70° C.

### SUMMARY OF THE INVENTION

One object of the present invention was to provide an improved process for the production of low-gel, high molecular weight isoolefin copolymers in the presence of vanadium compounds, in particular for the production of butyl rubbers.

Another object was to provide an alternative process for the production of low-gel, high molecular weight isoolefin copolymers in the presence of vanadium compounds, in particular for the production of butyl rubbers.

Another object was to provide isoolefin copolymers synthesized from isobutene, isoprene and optionally further monomers with an elevated comonomer content, an adequate molecular weight M_{w} and a low gel content.

It has now surprisingly been found that gelation may be suppressed at relatively low temperatures and relatively high comonomer concentrations while using vanadium tetrachloride as initiator in halogenated solvents, if the copolymerization of isoolefins and dienes is performed in the presence of catalytic quantities of organic nitro compounds.

The present invention accordingly provides a process for the production of low-gel isoolefin copolymers in the presence of vanadium compounds, characterised in that polymerization is performed in the presence of nitro compounds.

### DETAILED DESCRIPTION OF THE INVENTION

The process is preferably used for isoolefins with 4 to 16 carbon atoms and with dienes copolymerizable with the isoolefins, optionally in the presence of further monomers copolymerizable with the monomers. Isobutene and isoprene are more preferably used in the presence of further monomers copolymerizable therewith.

The process is preferably performed in a suitable solvent, such as chloroalkanes, in such a manner that the vanadium compound only comes into contact with the nitro-organic compound in the presence of the monomer.

The nitro compounds used in this process are widely known and generally available. The nitro compounds preferably used according to the invention are defined by the general formula (I)

R—NO₂ (I)

wherein R is selected from the group H, C₁-C₁₈ alkyl, C₃-C₁₈ cycloalkyl or C₆-C₂₄ cycloaryl.

C₁-C₁₈ alkyl is taken to mean any linear or branched alkyl residues with 1 to 18 C atoms known to the person skilled in the art, such as methyl, ethyl, n-propyl, i-propyl, n-butyl, i-butyl, t-butyl, n-pentyl, i-pentyl, neopentyl, hexyl and further homologues, which may themselves in turn be substituted, such as benzyl. Substituents, which may be considered in this connection, are in particular alkyl or alkoxy and cycloalkyl or aryl, such benzoyl, trimethylphenyl, ethylphenyl. Methyl, ethyl and benzyl are preferred.

C₆-C₂₄ aryl means any mono- or polycyclic aryl residues with 6 to 24 C atoms known to the person skilled in the art, such as phenyl, naphthyl, anthracenyl, phenanthracenyl and fluorenyl, which may themselves in turn be substituted. Substituents which may in particular be considered in this connection are alkyl or alkoxyl, and cycloalkyl or aryl, such as toloyl and methylfluorenyl. Phenyl is preferred.

C₃-C₁₈ cycloalkyl means any mono- or polycyclic cycloalkyl residues with 3 to 18 C atoms, such as cyclopropyl, cyclobutyl, cyclopentyl, cyclohexyl, cycloheptyl, cyclooctyl and further homologues, which may themselves, in turn, be substituted. Substituents which may, in particular, be considered in this connection are alkyl or alkoxy, and cycloalkyl or aryl, such as benzoyl, trimethylphenyl, ethylphenyl. Cyclohexyl and cyclopentyl are preferred.

The concentration of the organic nitro compound in the reaction medium is preferably in the range from 1 to 1000 ppm, more preferably in the range from 5 to 500 ppm. The ratio of nitro compound to vanadium is preferably of the order of 1000:1, more preferably of the order of 100:1 and most preferably in the range from 10:1 to 1:1.

The monomers are generally polymerized cationically at temperatures in the range from −120° C. to +20° C., preferably in the range from −90° C. to −20° C., and pressures in the range from 0.1 to 4 bar.

Inert solvents or diluents known to the person skilled in the art for butyl polymerization may be considered as the solvents or diluents (reaction medium). These comprise alkanes, chloroalkanes, cycloalkanes or aromatics, which are frequently also mono- or polysubstituted with halogens. Hexane/chloroalkane mixtures, methyl chloride, dichloromethane or the mixtures thereof may be mentioned in particular. Chloroalkanes are preferably used in the process according to the present invention.

Suitable vanadium compounds are known to the person skilled in the art from EP-A1-818 476. Vanadium chloride is preferably used. This may advantageously be used in the form of a solution in an anhydrous and oxygen-free alkane or chloroalkane or a mixture of the two with a vanadium concentration of below 10 wt. %. It may be advantageous to store (age) the V solution at room temperature or below for a few minutes up to 1000 hours before it is used. It may be advantageous to perform this aging with exposure to light.

Polymerization may be performed both continuously and discontinuously. In the case of continuous operation, the process is preferably performed with the following three feed streams:

I) solvent/diluent+isoolefin (preferably isobutene)

II) diene (preferably isoprene)+ organic nitro compound

III) vanadium compound (preferably VCl₄ in solvent).

In the case of discontinuous operation, the process may, for example, be performed as follows:

The reactor, precooled to the reaction temperature, is charged with solvent or diluent, the monomers and the nitro compound. The initiator is then pumped in the form of a dilute solution in such a manner that the heat of polymerization may be dissipated without problem. The course of the reaction may be monitored by means of the evolution of heat.

All operations are performed under protective gas. Once polymerization is complete, the reaction is terminated with a phenolic antioxidant, such as, for example, 2,2′-methylenebis(4-methyl-6-tert.-butylphenol), dissolved in ethanol.

Using the process according to the present invention, it is possible to produce novel high molecular weight isoolefin copolymers having elevated double bond contents and simultaneously low gel contents. The double bond content is determined by proton resonance spectroscopy.

The present invention accordingly also provides isoolefin copolymers synthesized from isobutene, isoprene and optionally further monomers with a diene content (comonomer content) of greater than 2.5 mol %, a molecular weight M_{w} of greater than 240 kg/mol and a gel content of less than 1.2 wt. %.

These polymers are ideally suitable for the production of moldings of all kinds, in particular tire components, very particularly “inner liners”, and industrial rubber articles, such as bungs, damping elements, profiles, films, coatings. The polymers are used to this end in pure form or as a mixture with other rubbers, such as NR, BR, HNBR, NBR, SBR, EPDM or fluororubbers.

The following Examples are provided to illustrate the present invention:

### EXAMPLES

### Experimental Details

Gel contents were determined in toluene after a dissolution time of 24 hours at 30° C. with a sample concentration of 12.5 g/l. Insoluble fractions were separated by ultra-centrifugation (1 hour at 20000 revolutions per minute and 25° C.).

The solution viscosity η of the soluble fractions was determined by Ubbelohde capillary viscosimetry in toluene at 30° C.

GPC analysis was performed by a combination of four, 30 cm long columns from the company Polymer Laboratories (PL-Mixed A). The internal diameter of the columns was 0.75 cm). Injection volume was 100 μl. Elution with THF was performed at 0.8 ml/min. Detection was performed with a UV detector (260 nm) and a refractometer. Evaluation was performed using the Mark-Houwink relationship for poly-isobutylene (dn/dc= 0.114; α=0.6; K=0.05).

The solvents and monomers used were desiccated before the reactor was charged (methyl chloride with Sicapent; isobutene with sodium on aluminum oxide; isoprene with calcium hydride). The nitro compounds were distilled under protective gas.

### Example 1 Comparative Example

300 g (5.35 mol) of isobutene were initially introduced together with 700 g of methyl chloride and variable quantities of isoprene at −90° C. under an argon atmosphere and with exclusion of light. A solution of vanadium tetrachloride in hexane (concentration: 0.62 g of vanadium tetrachloride in 25 ml of n-hexane) was slowly added drop-wise (duration of feed approx. 15-20 minutes) to this mixture until the reaction started (detectable by an increase in the temperature of the reaction solution).

After a reaction time of approx. 10-15 minutes, the exothermic reaction was terminated by adding a precooled solution of 1 g of 2,2′-methylenebis(4-methyl-6-tert.-butylphenol) (Vulkanox BKF from Bayer AG, Leverkusen) in 250 ml of ethanol. Once the liquid had been decanted off, the precipitated polymer was washed with 2.5 l of ethanol, rolled out into a thin sheet and dried for one day under a vacuum at 50° C.

The results are shown in Table 1 below:

TABLE 1
Results from Example 1 a-h

| | | | | | | | | | | Intrinsic | | Degree of | |
|---|---|---|---|---|---|---|---|---|---|---|---|---|---|
| | | | | | | | | | | vis- | Gel | swelling | Isoprene in |
| | Isoprene | Isoprene | Isoprene | VCl₄ | VCl₄ | Conversion | Mn | Mw | Mw/ | cosity | content | (toluene, | corporation |
| | (g) | (mol) | (mol %) | (g) | (mol) | (%) | (g/mol) | (g/mol) | Mn | (dl/g) | (wt. %) | 25° C.) | in mol % |
| a | 15.2 | 0.22 | 4.01 | 0.120 | 0.00063 | 4.73 | 233100 | 993000 | 4.26 | 2.05 | 0.9 | 57.4 | 1.9 |
| b | 17.2 | 0.25 | 4.51 | 0.120 | 0.00063 | 16.99 | 102100 | 703100 | 6.89 | 1.625 | 29.3 | 31.5 | 2.7 |
| c | 19.3 | 0.28 | 5.03 | 0.145 | 0.00075 | 19.42 | 71660 | 622900 | 8.69 | 1.465 | 9.2 | 34.8 | 3.6 |
| d | 21.2 | 0.31 | 5.5 | 0.145 | 0.00075 | 14.63 | 61390 | 499500 | 8.14 | 1.256 | 40.6 | 30.5 | 3.7 |
| e | 23.3 | 0.34 | 6.01 | 0.193 | 0.00100 | 16.49 | 44820 | 367400 | 8.20 | 1.001 | 25.4 | 25.1 | 5.9 |
| f | 25.3 | 0.37 | 6.5 | 0.169 | 0.00088 | 12.67 | 67090 | 430000 | 6.41 | 1.079 | 51.8 | 24.1 | 4.2 |
| g | 27.4 | 0.4 | 7 | 0.217 | 0.00113 | 11.18 | 57320 | 330100 | 5.76 | 0.707 | 61.8 | 21 | 5.7 |
| h | 29.5 | 0.43 | 7.49 | 0.169 | 0.00088 | 5.77 | 66510 | 279200 | 4.20 | 0.723 | 61 | 34.9 | 7.8 |

### Example 2 Example According to the Present Invention

The tests from Example 1 were repeated, with the difference that a quantity 0.61 g (9.99 mmol) of nitromethane was added to the monomer solution before the beginning of the reaction. All other test conditions remained unchanged.

The results are shown in Table 2 below:

TABLE 2
Results from Examples 2 a-h

| | | | | | | | | | | Intrinsic | | Degree of | |
|---|---|---|---|---|---|---|---|---|---|---|---|---|---|
| | | | | | | | | | | vis- | Gel | swelling | Isoprene in |
| | Isoprene | Isoprene | Isoprene | VCl₄ | VCl₄ | Conversion | Mn | Mw | Mw/ | cosity | content | (toluene, | corporation |
| | (g) | (mol) | (mol %) | (g) | (mol) | (%) | (g/mol) | (g/mol) | Mn | (dl/g) | (wt. %) | 25° C.) | in mol % |
| a | 15.2 | 0.22 | 4.01 | 0.289 | 0.00150 | 3.30 | 181300 | 684300 | 3.77 | 1.412 | 0.7 | 55.6 | 2.5 |
| b | 17.2 | 0.25 | 4.51 | 0.313 | 0.00163 | 3.31 | 143700 | 554000 | 3.86 | 1.31 | 0.6 | 73.4 | 2.5 |
| c | 19.3 | 0.28 | 5.03 | 0.361 | 0.00188 | 5.64 | 121000 | 454700 | 3.76 | 1.348 | 0.8 | 45.9 | 3.1 |
| d | 21.2 | 0.31 | 5.5 | 0.386 | 0.00200 | 3.61 | 116000 | 370600 | 3.19 | 1.271 | 0.9 | 50.8 | 3.4 |
| e | 23.3 | 0.34 | 6.01 | 0.554 | 0.00288 | 4.67 | 79170 | 243100 | 3.07 | 1.05 | 1.1 | 33.4 | 3.8 |
| f | 25.3 | 0.37 | 6.5 | 0.361 | 0.00188 | 3.20 | 124100 | 388900 | 3.13 | 1.208 | 0.8 | 44.9 | 3.7 |
| g | 27.4 | 0.4 | 7 | 0.361 | 0.00188 | 2.57 | 126000 | 412100 | 3.27 | 1.28 | 0.8 | 59.8 | 4.7 |
| h | 29.5 | 0.43 | 7.49 | 0.361 | 0.00188 | 2.76 | 84460 | 273000 | 3.23 | 1.272 | 6 | 25.8 | 4.7 |

To facilitate comparison, the results from the two tests are contrasted in Table 3 below:

| | Isoprene in feed | Gel content without | Gel content with |
|---|---|---|---|
| | (mol %) | nitromethane (wt. %) | nitromethane (wt. %) |
| a | 4.01 | 0.9 | 0.7 |
| b | 4.51 | 29.3 | 0.6 |
| c | 5.03 | 9.2 | 0.8 |
| d | 5.5 | 40.6 | 0.9 |
| e | 6.01 | 25.4 | 1.1 |
| f | 6.5 | 51.8 | 0.8 |
| g | 7 | 61.8 | 0.8 |
| h | 7.49 | 61 | 6 |

The dramatic fall in gel content due to the addition of nitromethane is clearly evident.

1. A process for producing low-gel isoolefin copolymers in the presence of vanadium compounds comprising the step of polymerizing monomers in the presence of organic nitro compounds.

2. A process according to claim 1, wherein said organic nitro compound is of the general formula (I)
R—NO₂ (I)
wherein R represents H, C₁-C₁₈ alkyl, C₃-C₁₈ cycloalkyl or C₆-C₂₄ cycloaryl.

3. A process according to claim 1, wherein the concentration of said organic nitro compound in the reaction medium is in the range from 1 to 1000 ppm.

4. A process according to claim 1, wherein said vanadium compound is VCl₄.

5. A process according to claim 1, wherein said monomers is isobutene, which is copolymerized with isoprene and optionally further monomers.

6. Isoolefin copolymers synthesized from isobutene, isoprene and optionally further monomers with a diene content (comonomer content) of greater than 2.5 mol %, a molecular weight M_{w} of greater than 240 kg/mol and a gel content of less than 1.2 wt. %.
